(19) United States
(12) Patent Application Publication
(10) Pub. No.: US 2002/0099473 A1
(43) Pub. Date: Jul. 25, 2002

(54) Integrated computer-aided design (CAD) and robotic systems for rapid prototyping and manufacture of smart cards

(76) Inventors: Paul Amadeo, San Diego, CA (US); Jose Flores, San Diego, CA (US)

Correspondence Address: KENYON S. JENCKES, Fish & Richardson P.C., Suite 500, 4350 La Jolla Village Drive, San Diego, CA, 92122, US

(21) Appl. No.: 09/976,680

(22) Filed: Oct. 12, 2001

Related U.S. Application Data
(60) Provisional application No. 60/247,422, filed on Nov. 8, 2000.
(60) Provisional application No. 60/247,455, filed on Nov. 8, 2000.

(51) Int. Cl. G05B 19/04

(52) U.S. Cl. 700/251

(57) ABSTRACT

A contactless smart card manufacturing system integrates computer-aided design (CAD) system and robotic systems to enable rapid set up for a new production design and rapid prototyping of a smart card designs. A user generates a CAD drawing representative of a desired smart card design. A robotic system uses the information in the CAD drawing file, e.g., Cartesian coordinates representative of desired feature dimensions and locations on the card, to control robotic systems to produce the desired feature in a smart card assembly.

### CROSS-REFERENCE TO RELATED APPLICATIONS

This application claims priority to U.S. Provisional Application Serial No. 60/247,422, filed on Nov. 8, 2000 and entitled “Integration of CAD and Robotic Systems for Rapid and Universal Formal Changes in the Manufacturing of Contactless Smart Cards” and to U.S. Provisional Application Serial No. 60/247,455, filed on Nov. 8, 2000 and entitled “Integration of CAD and Robotic Systems for Rapid Prototyping of Antenna for the Manufacture of Contact Less Smart Cards.”

### BACKGROUND

Smart cards are plastic cards that incorporate an integrated circuit (IC) chip with some form of memory. Many smart cards are wallet-sized, as specified by International Standard organization (ISO) standards. These international standards specify physical characteristics of cards, transmission protocols, and rules for applications and data elements.

Memory-based smart cards include memory and some non-programmable logic. Such cards may be used as personal identification cards or phone cards. More complex processor-based smart cards may include a central processing unit (CPU) and ROM for storing an operating system, a main memory (RAM), and a memory section for storing application data (usually an EEPROM). Processor-based smart cards may be used where heavy calculations or more security is required.

Smart cards may fall into one of two categories: contact and contactless. Contact cards must be inserted into a card reader to be accessed. Contact cards include an interconnect module, usually gold plated, with contact pads. The interconnect module may include power, reset, ground, serial input/output (SIO), and clock signal contact pads, as laid out in ISO 7816. The contact pads are physically contacted by pins in the reader to power and communicate with the IC chip. Contact cards are commonly used as telephone prepayment cards and bank cards.

Contactless cards do not require contact with the reader to be accessed. Contactless cards include an antenna embedded in the card which may be used for power transmission and communication by radio signals or capacitive inductance. Some advantages of contactless cards over contact cards include faster transactions, ease of use, and less wear and tear on the cards and readers.

Hybrid and dual-interface cards include aspects of both contact and contactless cards. Hybrid cards have two microelectronic modules (“chips”), each with its respective contact and contactless interface. Dual-interface, or “combi,” cards have a single module with both contact and contactless interfaces.

While different types of smart cards may conform to the same ISO specifications and hence share certain features and dimensions, there are countless design variations which can fall within these specifications. For example, the position of the module(s), the size, pattern, and type of the antenna, and the location of the wire bond between the chip and the antenna may differ in different cards and still conform to the same standard. The parameters may differ between card suppliers, card types (e.g., contactless, hybrid, and combi-card types) and the intended use of the card.

### SUMMARY

In an embodiment, a contactless smart card manufacturing system integrates computer-aided design (CAD) system and robotic systems to enable rapid set up for a new production design and rapid prototyping of a smart card designs.

A user generates a CAD drawing representative of a desired smart card design. A robotic system uses the information in the CAD drawing file, e.g., Cartesian coordinates representative of desired feature dimensions and locations on the card, to control robotic systems to produce the desired feature in a smart card assembly. The desired features may include the position of the integrated circuit (IC) module, a wire wound antenna pattern, and the position of bonds between the wire antenna and the IC module.

### BRIEF DESCRIPTION OF THE DRAWINGS

FIG. 1 is a block diagram of an integrated computer-aided design (CAD) and robotic system controller system according to an embodiment.

FIG. 2 is a sectional view of a smart card according to an embodiment.

FIG. 3A is a plan view of a sheet including a number of card modules according to an embodiment.

FIG. 3B is an expanded view of one of the card modules of FIG. 3A.

FIG. 4 is a perspective view of a pick-and-place workcell according to an embodiment.

FIG. 5 is a perspective view of a wire antenna implanting workcell according to an embodiment.

FIG. 6 is a flowchart describing a CAD controlled smart card production operation according to an embodiment.

FIG. 7 is a CAD drawing of an exemplary smart card design.

### DETAILED DESCRIPTION

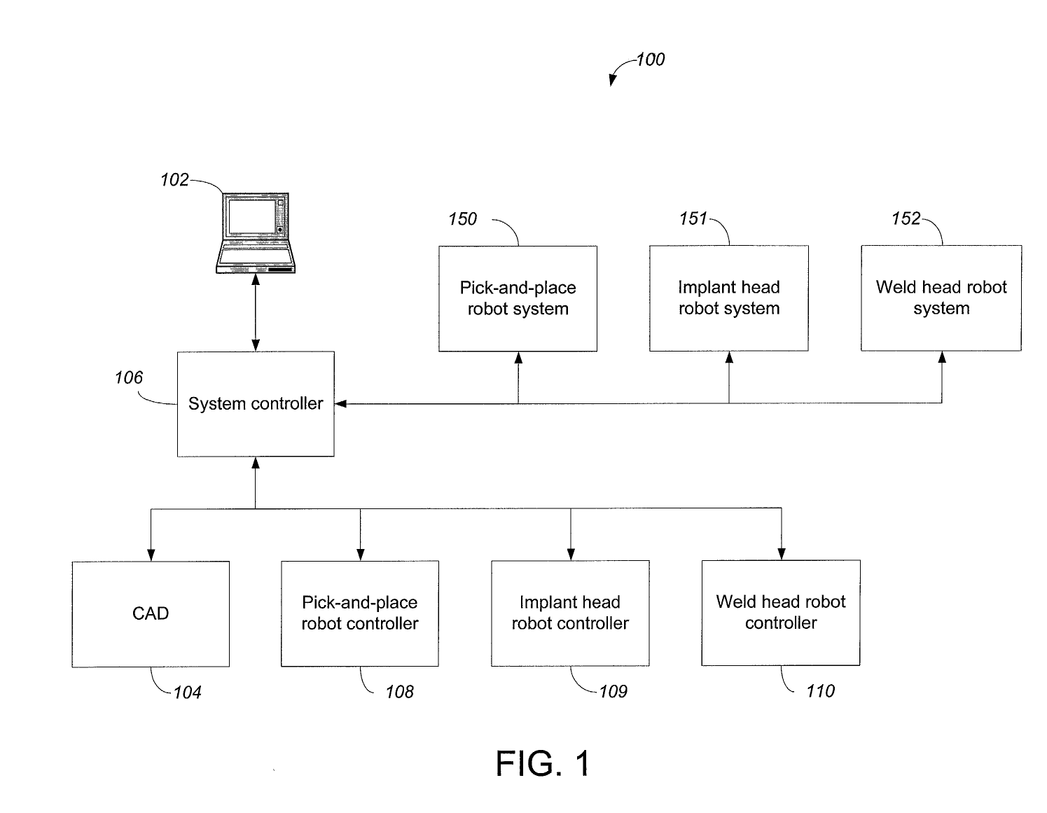

FIG. 1 illustrates smart card manufacturing system 100. The system 100 includes a computer 102 that integrates a computer-aided design (CAD) system and a robotic system controller to control robotic systems 150-152 used in the manufacture of contactless smart cards, which may include standard contactless cards as well as hybrid and combi-cards that include antennas. The computer 102 may be a specially constructed and dedicated CAD system or a general-purpose workstation or personal computer (PC) running CAD software 104.

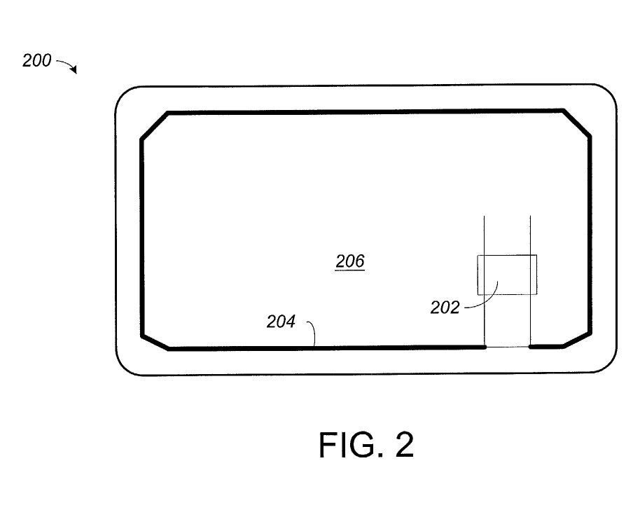

FIG. 2 illustrates a contactless smart card 200 according to an embodiment. The contactless card 200 contains a microelectronic module, e.g., an integrated circuit (IC) chip, 202 connected to a wire-wound antenna 204 embedded in a plastic card layer 206. The antenna 204 may include three or four turns of wire and is generally located around the perimeter of the card. The card may conform to International Standard Organization (ISO) 14443 or 15693, an international standard for remote coupling contactless cards. ISO specifies physical, mechanical, and electrical features of the card and the communication protocols between the card and the reader, without restricting the architecture of the IC chip in the card or the application for the card. A popular architecture for such contactless smart cards is the Mifare architecture and related protocols developed by Philips Semiconductor.

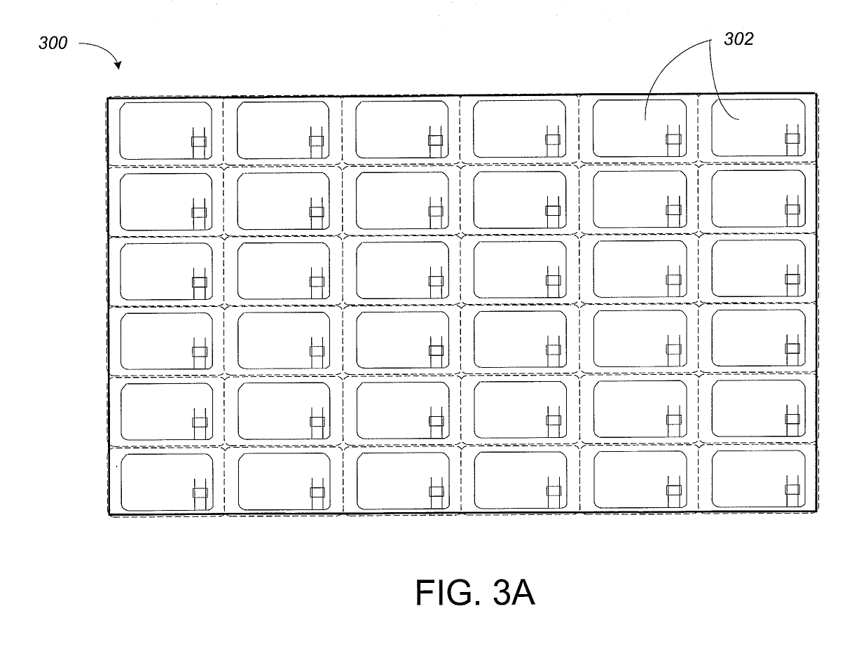

A batch of contactless smart cards may be manufactured simultaneously from a single sheet 300 of plastic, e.g., Polyvinyl Chloride (PVC) or Acrylonitrile Butadiene Styrene (ABS), as shown in FIGS. 3A and 3B. The plastic sheet 300 forms the substrate of the smart card modules 302 that are subsequently cut from the sheet 300.

The smart cards may be manufactured in a production line including multiple workcells. Each workcell performs a different operation in the manufacturing process on a batch of smart cards on the sheet 300 to form progressively developed subassemblies. A subassembly may be transferred to the next workcell in the production line for a subsequent manufacturing operation. The workcells may include a hole punching workcell, a module pick-and-place workcell, an antenna embedding workcell, an antenna/module interconnect (bonding) workcell, a lamination press workcell, and a card cutting workcell.

The hole punching workcell is used to punch holes or cavities into the sheets 300. The holes accommodate the volume of the IC module 304 that is inserted into the cavity at a later stage of the assembly process.

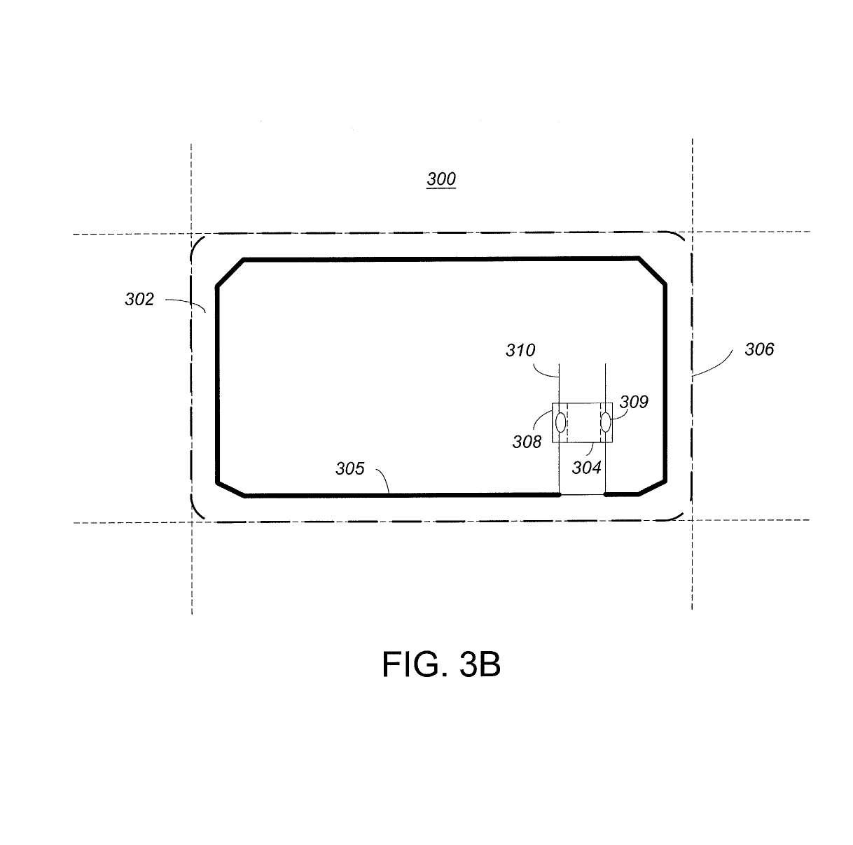

After the holes have been punched, the subassembly is transferred to a pick-and-place workcell 400, such as that shown in FIG. 4. IC modules 304 come on a standard 35 mm tape and are separated individually from the tape with a punching device. The singulated modules 304 are placed into a shuttle that transports them to a presentation point for a pick-and-place robot 402.

The robot 402 moves a vacuum head and a sensor to a programmed location. The sensor checks to see if the module is defective. Defective modules may be removed from the shuttle and placed into a holding bin. Good modules are removed from the presentation shuttle and placed at a specified location on the sheet 300. The module 304 may be secured in place with a cyno-acrylic adhesive, which is precisely applied using an industry standard dispensing system.

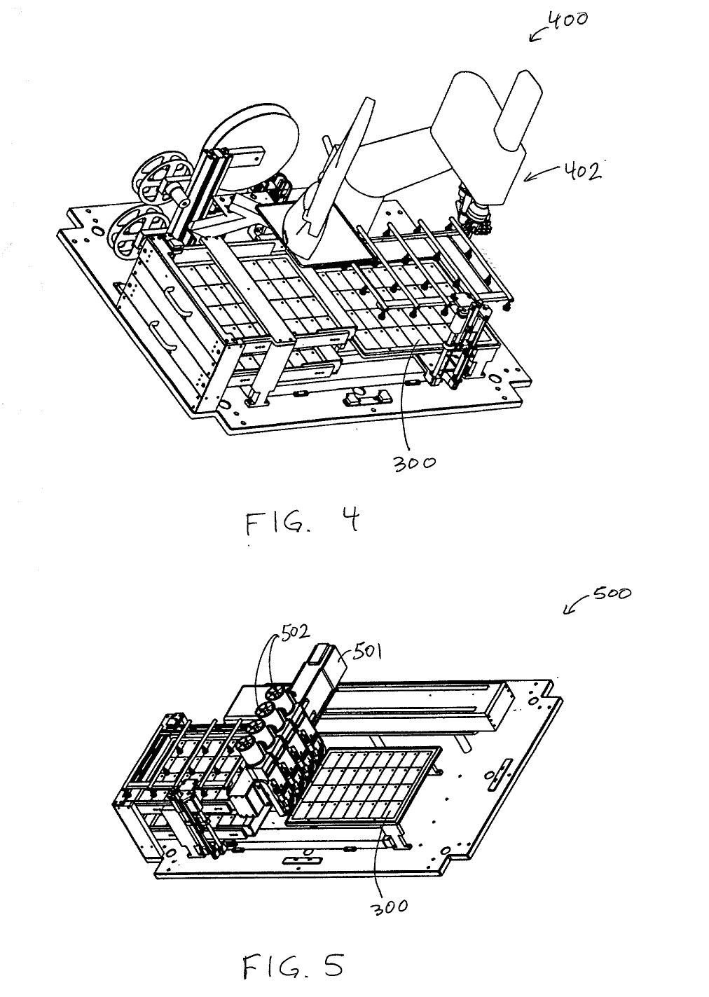

The subassembly is then transferred to the antenna embedding workcell 500, such as that shown in FIG. 5. The card antennas 305 may be embedded using a staking technique, in which an insulated wire is heated and pressed into the plastic card substrate by a wiring horn, through which the wire is fed. An ultrasonic transducer may be sued to heat the wire, which is forced into the card substrate. The heated wired liquefies the plastic it contacts. The liquefied plastic mechanically captures the wire as it is pressed into the substrate.

A robotic system 501 may move the implanting heads 502 in the antenna pattern. Each implanting head includes a wiring horn, an ultrasonic transducer, an actuator (e.g., a mechanical or voice coil), and a wire feeder/cutter, such that the heated wire is continuously fed from the wiring horn and embedded into the plastic card substrate as the implanting head is moved in a desired antenna pattern. The wire, which may be a polyester insulated copper wire about 4 mils in diameter, may be embedded into a card substrates having thicknesses between about 0.1 mm to 0.3, and comprising different types of plastic, e.g., PC, PVC, ABS, PET, or PETG.

After the wire antennas 305 are embedded, the subassembly is transferred to the bonding workcell. The ends 310 of the wire antennas 305 are bonded to the IC module 304 to provide electrical interconnection between the IC module 304 and the antenna 305 in each card module.

Each IC module 304 may include two contact tabs 308 for interconnection with the two ends 310 of the associated wound wire antenna 304 of the card module. The ends 310 of the wire antenna may be bonded to the contact tabs 308 using thermo-compression welding techniques. A robotic system 152 may control the position of a weld head and the heat and pressure used to generate the bonds. Since the wire antenna is used to supply power to the IC module and to enable the IC module to communicate with a card reader, it is critical that a good bond is formed between the wire antenna and the IC module.

After wire bonding, the subassembly is transferred to the lamination press workcell and laminated on both sides. The laminated sheet is then transferred to the card cutting workcell, which cuts the sheet 300 into the individual smart cards 200.

The pick-and-place workcell, antenna embedding workcell, and wire bonding workcell may each include robotic systems to control the movement and operation of the pick-and-place robot 402, the wire implanting heads 502, and the weld head, respectively. In an embodiment, the computer 102 includes a system controller 106 which integrates the CAD software 104 and the various robot controller operating systems and software 108-110.

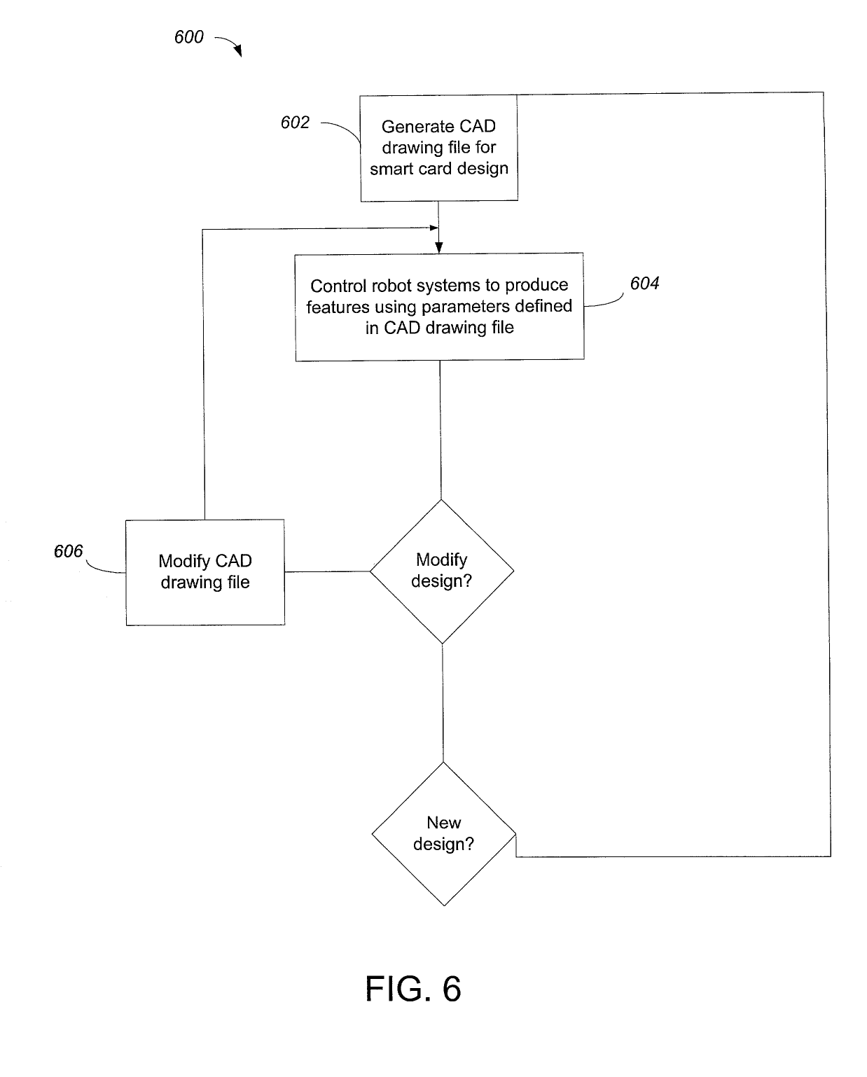

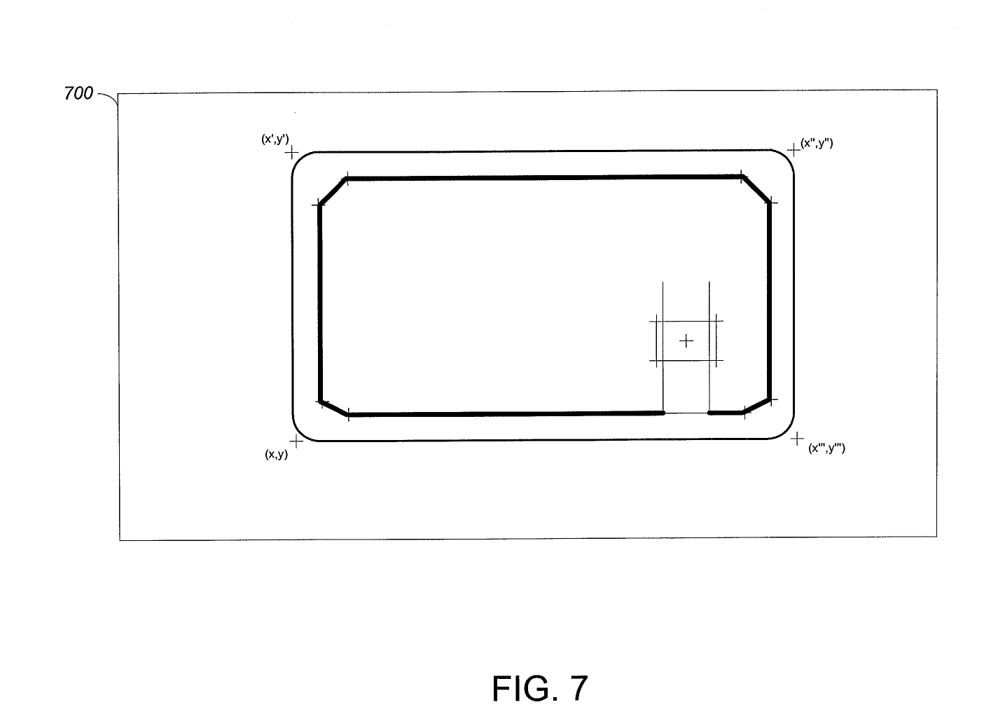

FIG. 6 is a flowchart describing a CAD controlled smart card production operation 600 according to an embodiment. The computer 102 may include a high quality graphics monitor and a input device such as a mouse, light pen, or digitizing tablet to enable a user to generate a CAD drawing representative of a desired smart card design (block 602). FIG. 7 illustrates an exemplary CAD drawing 700. Alternatively, the user may load an existing CAD drawing file corresponding to the desired format.

The CAD drawing 700 includes parameters for the desired design which may include, for example, Cartesian coordinates (x-, y-, z-axes) for the location of features on the card. The features may include the location of the IC module 304, the position of the wire bonds 309 between the antenna ends 310 and the contact tabs 308 of the IC module, and the wire antenna pattern 305, including, e.g., size, shape, and number of windings. The CAD drawing may be two-dimensional (2-D) and describe the locations and dimensions of features on the card surface, or three-dimensional (3-D), further describing the thickness of the card and the depth of the features. The computer 102 uses the information in the CAD drawing control the various robotic systems 150-152 to produce the features described in the CAD drawing on the actual smart card modules 302 (block 604).

The CAD software 104 keeps track of design dependencies so that when the user changes one value, other values that depend from that value are automatically changed accordingly. The CAD software may also include parameter limitations, such as minimum and maximum values, that correspond to ranges and tolerances in the appropriate ISO specification for the type of cards under production. The CAD software may use this information to ensure that the CAD drawing created by the user, and any contact cards produced using that drawing, conform to the appropriate specification.

Other parameters used by the robotic systems 150-152 may be associated with the CAD drawing file. These parameters may include, for example, the speed, pressure, and ultrasonic energy values used by the implant robot controller 109 to control the implanting head when staking the wire antenna in the card substrate, and the heat and pressure values used by the weld robot controller 110 to control weld head during the thermo-compression welding operation.

In conventional smart card production lines, modifications in a production design and switching to a different production design could require extensive modification of equipment, and of the data and software used to control that equipment, in one or more workcells. For example, in the case of production lines used to manufacture smart cards that include etched antennas, new masks would have to be created for a new design. However, in the present embodiment, a format for a particular smart card in production may be changed relatively easily by modifying parameters in the CAD drawing file (block 606). This integrated software approach results in relatively fast product development time. Also, the system can change to a different production design for a different production design with a minimal set up time by generating or loading a new CAD drawing file (block 602).

The operations performed by the system and its components may be implemented in hardware or software, or a combination of both (e.g., programmable logic arrays). Unless otherwise specified, the algorithms included as part of the operation are not inherently related to any particular computer or other apparatus. In particular, various general purpose machines may be used with programs written in accordance with the teachings herein, or it may be more convenient to construct more specialized apparatus to perform the required method steps. However, preferably, the invention is implemented in one or more computer programs executing on programmable systems each comprising at least one processor, at least one data storage system (including volatile and non-volatile memory and/or storage elements), at least one input device, and at least one output device. Program code is applied to input data to perform the functions described herein and generate output information. The output information is applied to one or more output devices, in known fashion.

Each such program may be implemented in any desired computer language (including machine, assembly, high level procedural, or object oriented programming languages) to communicate with a computer system. In any case, the language may be a compiled or interpreted language.

Each such computer program is preferably stored on a storage media or device (e.g., ROM, CD-ROM, or magnetic or optical media) readable by a general or special purpose programmable computer, for configuring and operating the computer when the storage media or device is read by the computer to perform the procedures described herein. The system may also be considered to be implemented as a computer-readable storage medium, configured with a computer program, where the storage medium so configured causes a computer to operate in a specific and predefined manner to perform the functions described herein.

A number of embodiments have been described. Nevertheless, it will be understood that various modifications may be made without departing from the spirit and scope of the invention. Accordingly, other embodiments are within the scope of the following claims.

1. A method comprising:
generating a computer-aided design (CAD) drawing file including a desired contactless smart card design, said CAD drawing file including information description of desired card features,
accessing the information in the CAD drawing file; and
controlling a robotic system to produce one or more of said desired feature using the accessed information.

2. The method of claim 1, wherein the information comprises positional information in a Cartesian coordinate system.

3. The method of claim 1, wherein the information comprises a desired location for a corresponding feature.

4. The method of claim 1, wherein the information comprises the dimensions of the of a corresponding feature.

5. The method of claim 1, wherein the information includes parameters for an operation.

6. The method of claim 5, wherein said parameters include a speed value, an ultrasonic energy value, and a pressure value for controlling a wire antenna implanting apparatus.

7. The method of claim 6, wherein the feature comprises a wire antenna pattern and the information comprises a size and a shape of the wire and a number of windings.

8. The method of claim 1, wherein said controlling a robotic system comprises controlling a robotic system including a wire implanting apparatus operative to stake a wire antenna in a card substrate.

9. The method of claim 1, wherein said controlling a robotic system comprises controlling a pick-and-place robot operative to place an integrate circuit (IC) module in a hole in the card substrate.

10. The method of claim 9, wherein the information includes the length and width of the IC module in the card substrate and a desired location of the IC module in the card substrate.

11. The method of claim 1, wherein said controlling a robotic system comprises controlling a robotic system including a welding apparatus operative to bond ends of the wire antenna to contact tabs on an IC module.

12. The method of claim 11, wherein the information includes a desired position of the bonds.

13. The method of claim 1, further comprising:
modifying the CAD drawing file, said CAD drawing file including modified information description of at least one new desired card feature,
accessing the modified information in the CAD drawing file; and
controlling a robotic system to produce said new desired feature using the accessed information.

14. A robotic system controller comprising:
a display screen;
input means;
a CAD module operative to enable a user to generate a CAD drawing on the display screen and a corresponding CAD drawing file using said input means, said drawing file including information description of desired card features;
a memory device operative to store the CAD drawing file; and
a controller operative to access said information in the CAD drawing file and control a robotic system to produce one or more of said desired feature using the accessed information.

15. The robotic system controller of claim 14, wherein the information comprises a desired location for a corresponding feature.

16. The robotic system controller of claim 14, wherein the information comprises the dimensions of the of a corresponding feature.

17. The robotic system controller of claim 14, wherein the controller is further operative to control a robotic system including a wire implanting apparatus operative to stake a wire antenna in a card substrate.

18. The robotic system controller of claim 14, wherein the controller is further operative to control a pick-and-place robot operative to place an integrate circuit (IC) module in a hole in the card substrate.

19. The robotic system controller of claim 14, wherein the controller is further operative to control a robotic system including a welding apparatus operative to bond ends of the wire antenna to contact tabs on an IC module.

20. An article comprising a machine-readable medium including machine-operable instructions, the instructions operative to cause a machine to:
generate a computer-aided design (CAD) drawing file including a desired contactless smart card design, said CAD drawing file including information description of desired card features,
access the information in the CAD drawing file; and
control a robotic system to produce one or more of said desired feature using the accessed information.

21. The article of claim 20, wherein the information comprises positional information in a Cartesian coordinate system.

22. The article of claim 20, wherein the information comprises a desired location for a corresponding feature.

23. The article of claim 20, wherein the information comprises the dimensions of the of a corresponding feature.

24. The article of claim 20, wherein the information includes parameters for an operation.

25. The article of claim 24, wherein said parameters include a speed value, an ultrasonic energy value, and a pressure value for controlling a wire antenna implanting apparatus.

26. The article of claim 25, wherein the feature comprises a wire antenna pattern and the information comprises a size and a shape of the wire and a number of windings.

27. The article of claim 20, wherein the instructions for controlling a robotic system further comprise instructions causing the machine to control a robotic system including a wire implanting apparatus operative to stake a wire antenna in a card substrate.

28. The article of claim 20, wherein the instructions for controlling a robotic system further comprise instructions causing the machine to control a pick-place robot operative to place an integrate circuit (IC) module in a hole in the card substrate.

29. The article of claim 28, wherein the information includes the length and width of the IC module in the card substrate and a desired location of the IC module in the card substrate.

30. The article of claim 20, wherein the instructions for controlling a robotic system further comprise instructions causing the machine to control a robotic system including a welding apparatus operative to bond ends of the wire antenna to contact tabs on an IC module.

31. The article of claim 30, wherein the information includes a desired position of the bonds.

32. The article of claim 20, further comprising instructions operative to cause the machine to:
modify the CAD drawing file, said CAD drawing file including modified information description of at least one new desired card feature,
access the modified information in the CAD drawing file; and
control a robotic system to produce said new desired feature using the accessed information.
